(19) United States
(12) Patent Application Publication
(10) Pub. No.: US 2011/0137706 A1
(43) Pub. Date: Jun. 9, 2011

(54) FRAMEWORK AND SYSTEM FOR PROCUREMENT, IDENTIFICATION AND ANALYSIS OF POTENTIAL BUYERS OF REAL ESTATE

(76) Inventors: Christopher Brett Howard, Provo, UT (US); Michael S. Howard, Provo, UT (US)

(21) Appl. No.: 12/633,722

(22) Filed: Dec. 8, 2009

(51) Int. Cl. G06Q 30/00; G06Q 10/00; G06Q 50/00; G06F 17/00; G06K 19/06; G06F 17/30

(52) U.S. Cl. 705/7.29; 705/14.45; 235/375; 235/494; 235/492; 707/769; 707/609; 707/E17.005; 707/E17.014

(57) ABSTRACT

A method, computer program product and system are disclosed for procuring, identifying, collecting, analyzing and tracking potential buyers and investors of real property using an electronic network like the Internet. A central managing authority uses uniquely configured data processing devices and signage bearing QR Codes to induce potential buyers of real estate to electronically contact the central managing authority in manner which allows the central managing authority to track when, how and where the potential customers where induced to make contact. The disclosed method and system uniquely assist the central managing authority in the solicitation of the newly acquired sales leads to save expending inefficient amounts of time and money inherent in realizing traditional methods. Signage is printed bearing and RFID tag or two- or three-dimensional bar codes, such as a QR Code, and positioned in accordance with a predetermined criteria. Certain embodiments of the present invention include substitute means of identifying, soliciting, tracking, and analyzing potential buyers of real estate and other commercial offerings.

### BACKGROUND OF THE INVENTION

1. Field of the Invention

This invention relates to computer implemented processes, and more particularly relates to a signage and a data processing system for procuring, identifying, and electronically analyzing potential buyers, investors, contractors, and lessees of real estate using unique signage.

2. Description of the Related Art

Potential buyers of real estate and other large commercial products must consider a great deal more information than can be displayed on traditional drive-by signage in deciding whether or not to purchase, lease, sublease, or develop real estate. Increasingly, this information is accessed by potential buyers online via the Internet if the potential buyers can find the URLs containing the proper information after having their interest piqued. Potential buyers of real estate often lack the time or ability to transcribe long URLs displayed on signage when driving, or walking, by the signage. This reality has lead to the development of object hyperlinks, such as QR Codes and other two-dimensional matrices, which automatically direct individuals to target URLs when photographed and scanned with a digital camera, optical reader, bar code scanner, or the like.

Traditional signage, and current developments in the art, provide no means of identifying the exact time and date that a potential buyer became interested in real property advertised conventionally, or where a potential buyer was oriented with respect to the signage when his or her interest was piqued. Sellers and marketers of large commercial offerings such as real estate often decide to expend promotional advertising budgets on signage based only on traffic estimates usually generated by third-parties, and/or on estimated traffic conversion rates rather than the measured amounts of conversions themselves. For this reason, it is often difficult for real estate developers and marketers to know where to optimally position signage, what signage locations are worthy of marketing expenditures, and to otherwise optimize marketing campaigns.

The present invention beneficially teaches a uniquely configured species of signage and method of tracking potential buyers the signage generates that overcome prior shortcomings in art.

### SUMMARY OF THE INVENTION

From the foregoing discussion, it should be apparent that a need exists for a method, system, apparatus and computer program product for procuring, identifying and analyzing potential buyers, investors and lessees of real estate. The present invention has been developed in response to the present state of the art; and, in particular, in response to the problems and needs in the art that have not yet been fully solved by currently available methods, systems and apparatii, and that overcome many or all of the above-discussed shortcomings in the art. Accordingly, the present invention has been developed to provide an apparatus, method, computer program product, and system for procuring, identifying and analyzing potential buyers of real estate.

A computer program product is disclosed, comprising a computer readable medium, having computer usable program code executable to perform operations for procuring, identifying, and tracking potential buyers of a commercial product, the operations of the computer program product comprising: printing signage bearing a two-dimensional matrix bar code, wherein said matrix bar code stores object hyperlinks to a URL exclusively associated with the signage, wherein said signage advertises a commercial product; and storing the physical location of the signage in a database under the exclusive control of a central managing authority intending to profit from the sale of the commercial product; storing tracking information comprising the time, date, and location where the signage was photographed or scanned by a potential buyer, wherein said tracking information is derived from scripts embedded into the source code of a website to which the URL resolves.

The operation of the computer program product further comprise displaying information to the potential buyer about a commercial product via the website to which the URL resolves; requesting personal information about the potential buyer via the website; incorporating the personal information of the potential buyer into the database, said personal information structured in one or more computer readable files and comprising one or more of name, address, email, telephone number, employer, income, and profession; referencing the personal information and the tracking information in determining whether to reposition the signage; and referencing the personal information and the tracking information in determining where to situate new signage.

In some embodiments, the commercial product is real property and the matrix bar code is a QR Code. In other embodiments, the signage comprises a portable device selected from the group consisting of a shirt, grocery bag, hat, car, soda bottle, and kite. The signage may also comprise more than one matrix bar code combined into a lenticular print.

The lenticular print may be configured such that only one matrix bar code is visible from one or more predetermined positions relative to the signage. The computer program product may further comprise an operation of tracking the position from which a potential buyer was induced to contact the central managing authority.

The computer program product may further comprise an operation of predetermining an ideal physical location to display the signage by querying a database of available signage locations and by querying statistical historical data specific to a geographic location, the statistical historical data comprising one or more of traffic figures, population figures, demographic information, promotional expenditures for organizations competing with the central managing authority, reported profits, and fixed costs assigned to available signage locations.

In still further embodiments, the computer program product comprises repositioning the signage to a second ideal physical location as historical data in the database is updated and after the signage is originally positioned. The signage further may comprise an active RFID tag or the signage may comprise a passive RFID tag.

The computer program product may also further comprise an operation of notifying a client of the central managing authority that the one or more potential buyers have contacted the central managing authority through the URL and/or further comprise remunerating a third-party for each contact made with the central managing authority by a potential buyer.

A system and method are also disclosed, whose modules and operations are functionally similar to those of the computer program product.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for procurement, identification and analysis of potential buyers and investors of real estate in accordance with the present invention;

FIG. 2 is a block diagram illustrating one embodiment of a computer system for procurement, identification and analysis of potential buyers and investors of real estate in accordance with the present invention;

FIG. 3 is a flow chart of a method of procuring, identifying and analyzing potential buyers and investors of real estate in accordance with the present invention;

FIG. 4A is a front perspective view of signage printed in accordance with the present invention; and

FIG. 4B is a front perspective view of another embodiment of signage printed in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention. The apparatus modules recited in the claims may be configured to impart the recited functionality to the apparatus.

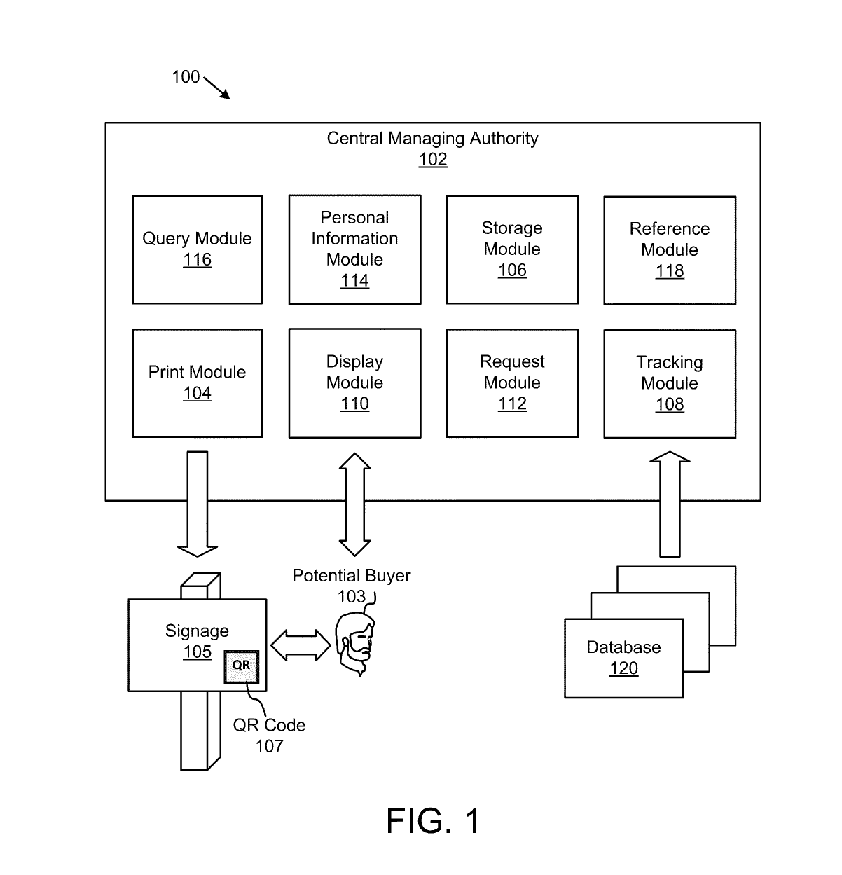

FIG. 1 is a schematic block diagram illustrating one embodiment of a system for procurement, identification and analysis of potential buyers and investors of real estate in accordance with the present invention. The system 100 comprises a central managing authority 102, a potential buyer 103, a print module 104, signage 105, a storage module 106, a QR Code 107, a tracking module 108, a display module 110, a request module 112, a personal information module 114, a query module 116, a reference module 118, and a database 120.

The central managing authority 102 may comprise any individual, organization, entity, or combination thereof, tasked with selling, marketing, holding and/or advertising real estate or other large commercial products and services such as machinery, aircraft, vehicles, waste disposal services, construction services, and the like.

The central managing authority 102 may also comprise a computer program running on one or more data processing devices (DPDs), such as a server, computer workstation, router, mainframe computer, or the like. In various embodiments, the DPD comprises one or more processors. The processor is a computing device well-known to those in the art and may include an application-specific integrated circuit (“ASIC”).

In the present invention, the central managing authority 102 may route information from the tracking module 108 and/or from the database 120 to any DPD, device, person, company, organization, or the like in communication with the central managing authority 102, including the owners of real estate.

In this embodiment, the central managing authority 102 stores tracking information gathered from the potential buyer 103 electronically via the Internet. The central managing authority 102 is in logical communication via the Internet with the cellular phones of potential buyers 103, or through other personal DPDs such as laptops, Palm Pilots®, digital cameras, and the like. Alternative, the central managing authority 102 may be in logical communication with potential buyers 103 through a networked environment, such as local area network (LAN) or wide area network (WAN).

In various embodiments, the central managing authority 102 may make available via the display module 110 information about a commercial offering, including pictures, written descriptions, and contact information. Alternatively, the central managing authority may email potential buyers 103 with information about the real estate or commercial offering using variations of the Simple Mail Transfer Protocol (SMTP), Internet Message Access Protocol (IMAP), Post Office Protocol (POP), or other protocols well-known to those of skill in the art.

The potential buyer 103 may comprise any individual, organization, or group of individuals and/or organizations, including a pedestrian, driver, pilot, construction worker, office worker, or anyone else who comes within view of commercial signage. Though referred to throughout this application as “potential buyers 103,” the potential buyers 103 may comprise individuals and/or organizations interested in buying real estate, interested in investing in real estate (such as real estate investment trusts and the like), interested in leasing real estate, interested in selling real estate, interested in constructing buildings on real estate, and the like.

The potential buyers are visually exposed to the signage 105, usually while driving, walking, or otherwise traversing within view of the signage's 105 face. In some embodiments, a plurality of streets, walkways, or buildings are within view of the face of the signage 105. It is one of the objects of the present invention to teach means of identifying the street, building, walkway, or location from which the signage 105 was viewed by one or more potential buyers 103 through the use of more than one QR Code 107 printed on the signage 105 as a lenticular print.

Lenticular prints are well-known to those of skill in the art. Lenticular prints comprise a plurality of two-dimensional images interlaced atop each other and combined into a single image or file. The interlaced image can be printed directly onto a substrate surface such as synthetic paper and overlaid with a lenticular lens. When properly created, lenticular prints create an illusion of depth or show a different image from the different angles and positions from which the lenticular print is viewed.

In the present invention, by printing the QR Codes 107 lenticularly, more than one QR Code 107 can be simultaneously printed in the same position on the signage 105 and potential buyers 103 who photograph or scan the signage 105 can be directed to specific URLs exclusively associated with the differing positions from which the potential buyer 103 photographed the QR Code 107.

By printing QR Codes 107 in this fashion, a central managing authority 102 can determine the position where a majority or minority of its potential buyers 103 became interested in purchasing real estate or other commercial offerings advertised on the signage 105.

The print module 104, in the shown embodiment, prints signage bearing one or more two-dimensional matrix bar codes, such as QR Codes 107. The matrix bar code comprises an object hyperlink. Digital cameras and other personal DPDs can be configured to recognize the matrix bar code and automatically direct potential buyers 103 to Uniform Resource Locators (URLs) and/or domain names on the Internet identified by the object hyperlink.

The print module 104 may determine what size text to use in printing the signage and/or which colors to use by referencing one or more databases or computer files external to the central managing authority 102 which contain information about the distance between roads or walkways fronting the signage 105. For greater distances, the print module 104 may print the signage with larger sized fonts than the print module 104 would for signage intended to be positioned in closer proximity to the potential buyers 103. Additionally or alternatively, in various embodiments, the print module 104 may print the signage 105 in colors predetermined to contrast with the surrounding topology and/or surrounding print media. To that end, the print module 104 may reference pictures of areas and objects surrounding the intended location of the signage 105.

The system 100 includes signage 105. The signage 105 may be square, rectangular, circular, triangular, or irregularly shaped. The QR Code 107 may be positioned anywhere on the signage 105, or above or below the post or bracket securing the signage 105. The signage 105 may comprise printed media, such as poster, billboard, pylon, magazine, business card, or marquee. In other embodiments, the signage 105 may comprise digital media, such as a computer screen publically displayed at sporting events or other public gatherings using technologies such as LCD, plasma, LED, cathode-ray projection, and the like.

The signage 105 be may fixed in place or transportable such as signage 105 appearing on the side of an automobile, on a bumper sticker, brochures, folders, shirts, hats, shoes, and the like. The signage 105 may appear in non-traditional locations, such as the bottom of swimming pools, or inscribed into fields in view of aircraft. The signage 105 may comprise a plurality of QR Codes 107 or other two-dimensional matrices. The signage 105 may be displayed adjacent to, and within view of, the commercial product or may be displayed remotely and out of view of the commercial product.

The storage module 106 stores the physical location of the printed signage 105. In accordance with some embodiments of the present invention, the central managing authority 105 predetermines an optimal location for the printed signage 105 to be displayed by referencing historical data comprising traffic figures, advertising costs, and socio-economic information about potential buyers 103 likely to see the signage 105.

The QR Code 107 comprises a two-dimensional bar code readable by digital cameras. QR Codes 107 are well-known to those of skill in the art. In the shown embodiment, the QR Code 107 comprises an object hyperlink to a URL exclusively associated with the signage 105.

When the QR Code 107 is photographed and/or scanned by a potential buyer 103, the potential buyer 103 is directed to a URL resolving to a website with information about a real estate offering. In some embodiments, the potential buyer 103 is automatically directed the URL upon photographing the QR Code 107. In other embodiments, the potential buyer 103 is directly later to the URL after activating DPDs in logical communication with the Internet or a wireless network.

In some embodiments of the present invention, the QR Code 107 may be digitally displayed to potential buyers, such as on a Jumbotron computer display at a sporting event. In embodiments comprising a digitally displayed QR Code, the QR Code 107 or substitute two-dimensional matrix may be printed dynamically onto the digital display such that it changes with passing time. In these embodiments, the QR Code 107 may comprise a timestamp indicating the exact or approximate time that the QR Code 107 was displayed so that the central managing authority 102 can determine for the purpose of storing tracking information the time that potential buyers 103 photographed the QR Code 107.

The signage 105 and/or the QR Code 107 may additionally or alternatively comprise passive and/or active radio frequency identification (RFID) tags well-known to those of skill in the art and scannable by potential buyers passing within view of the signage 105. The QR Codes 107 in the present invention may comprise Aztec Codes, barcodes, ShotCodes, touchtags, and the like.

The QR Code 107 may be printed in black-and-white, grayscale, or any combination of colors well-known to those of skill in the art, or printed lenticularly. The colors and size of the QR Code 107 may be automatically predetermined to be visible from predetermined distances away from the location of the signage 105.

The Internet is well-known to those of skill in the art. The Internet 104 may comprise any collection of interconnected computers and computer networks linked by Ethernet cables, wireless connections, and the like, such as the world-wide-web.

The commercial offering advertised on the signage 105 may comprise any valuable commercial items or services retailing for more than $25,000, less than or equal to $25,000, or real estate retailing for any price.

The tracking module is configured to identify the time, date, and location where the signage 105 was photographed or scanned by the potential buyers 103. The tracking information is derived, in some embodiments, from scripts embedded into the source code of a website to which the URL resolves which is displayed by the display module 110.

In some embodiments, the tracking module 108 identifies the time the QR Code 107 and/or signage 105 were photographed by referencing the clock of the central managing authority 102 when contact with the central managing authority 102 is initiated by the potential buyer 103. In other embodiments, the tracking module 108 determines when the QR Code 107 was scanned by referencing information dynamically displayed in QR Code 107 incorporated into digitally displayed signage 105.

The display module 110 displays information about the real estate or commercial offering to the potential buyer 103 via the Internet or other wireless connections.

The request module 112 prompts the potential buyer 103 to input personal information that is stored in the database 120.

The personal information may comprise a computer readable file transmittable over a signal bearing medium like the Internet and storable on a computer readable storage. The personal information may comprise one or more of: age, address, gender, credit rating, email, telephone number, income, education, and purchasing practices.

The personal information module 114 is configured, in some embodiments, to incorporate the personal information in one or more computer readable files or the database 120 for later reference by other modules in the system and/or method operations of the present invention.

The query module 116 is configured to reference personal information contained in the database 120 and/or the tracking information also stored in the database 120 to determine where the signage 105 needs to be repositioned and whether the signage 105 is profitable. The query module 116 may be configured to determine the degree to which a current signage location satisfies a predetermined criteria meant to identify the profitability of the signage 105.

The reference module 118 is configured to reference personal information contained in the database 120 and/or the tracking information also stored in the database 120 to determine where to situate new signage printed by the printing module 104. The reference module 118 may be configured to determine the degree to which proposed signage locations satisfy a predetermined cost-effective criteria meant to identify only profitable signage locations.

The database 120 comprises a database under the exclusive or non-exclusive control of the central managing authority 102. Databases are well-known to those of skill in the art. The database 120 preferably comprises a structured computer-readable file, but may also comprise a book, audio recording, video, digital image, or the like. The database 120 may comprise a relational computer database managed by a relational database management system (RDBMS) or a database management system (DBMS), such as Oracle, DB2, Firebird, SQL, or other DBMSs as are well-known to those of skill in the art.

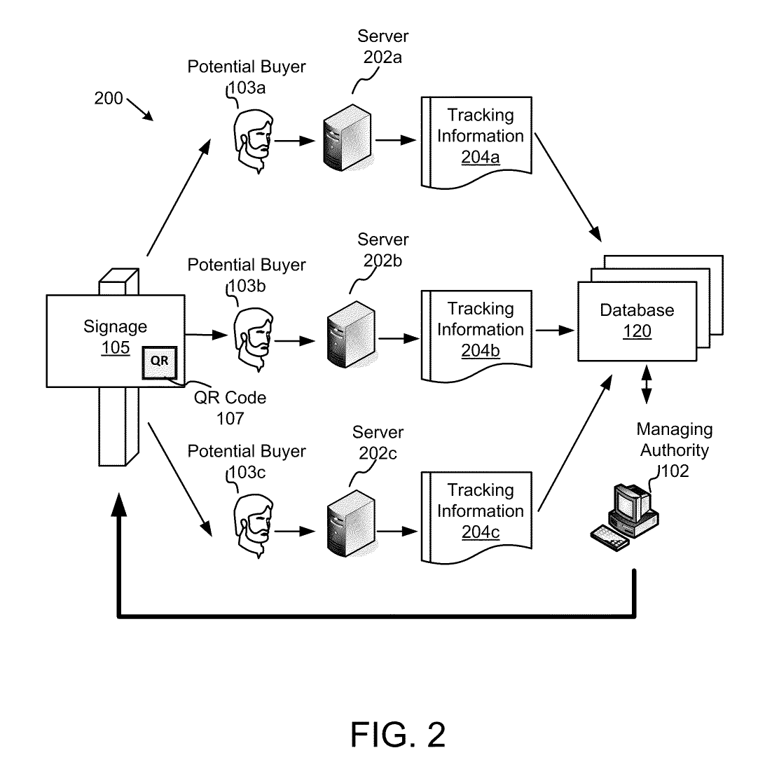

Referring now to FIG. 2, a block diagram illustrating one embodiment for procurement, identification and analysis of potential buyers and investors of real estate in accordance with the present invention. The computer system 200 includes a central managing authority 102, potential buyers 103a-c, signage 105, a QR Code 107, a database 120, servers 202a-c, and tracking information 204a-c.

The central managing authority 102, potential buyers 103a-c, signage 105, QR Code 107, and database 120 are substantially described above in relation to FIG. 1.

The central managing authority 102, in the shown embodiment, selects an optimal location to display the signage 105 from a list of available signage locations saved in computer readable memory and made accessible to the central managing authority 102 and its reference module 118. The central managing authority 102 references statistical historical data comprising the quantities of potential customers 103 that have contacted the central managing authority 102 or other third-parties who have advertised at each available location. The statistical historical data may also comprise cost data associated with advertising signage at each of the available locations.

The servers 202a-c comprise DPDs well-known to those of skill in the art.

In the shown embodiment, potential buyers 103a-c view the signage 105 comprising lenticularly printed QR Codes 107 and are directed to different URLs based on the locations exclusively associates with the location from which the potential buyers 103a-c viewed the signage 105. In the shown embodiment, differing servers 202a-c display differing websites to the potential buyers 103a-c, each website being exclusively associated with the URL that the potential buyers 103a-c were directed to.

The servers 202a-c collect tracking information 204a-c from the potential buyers 103a-c and transmit the tracking information 204a-c in computer readable files to the central managing authority 102 where the tracking information 204a-c is stored in persistent storage, such as in the database 120.

The tracking information comprises data useful in determining which signage 105 was photographed by the potential customer 103 and/or which QR Code 107 was photographed by the potential customer 103. The tracking information may comprise a timestamp indicating the time the signage 105 was photographed, the location where the signage 105 was located, and/or the orientation of a potential customer 103 to the signage 105.

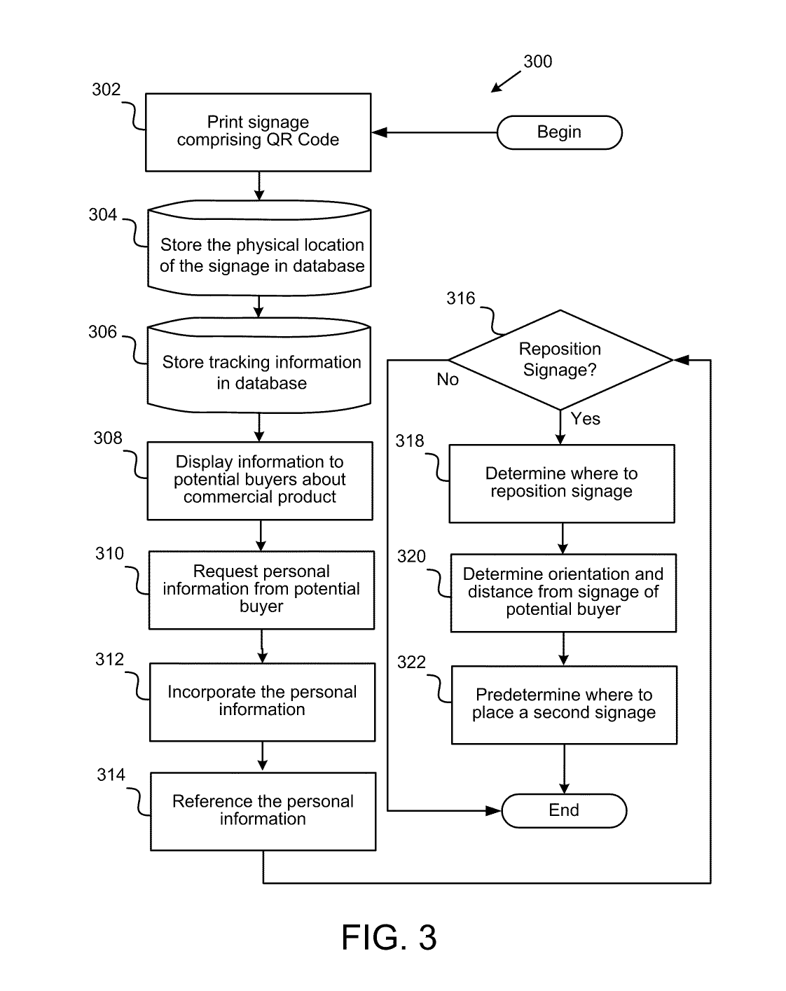

Referring now to FIG. 3, a flow chart of a method 300 of procuring, identifying and analyzing potential buyers and investors of real estate in accordance with the present invention.

The method 300 substantially includes the embodiments and modules described above with regard to the apparatus, computer program product, and system depicted in FIGS. 1-2.

The method 300 begins as signage 105 comprising a QR Code 107 is printed 302. The physical location where the signage 105 is positioned is then stored 304 in the database 120. In alternate embodiments of the present invention, the signage 105 is positioned in a location predetermined by the central managing authority 102 to be the optimal choice from a finite group of possibilities based an analysis of historical data.

The method 300 proceeds as shown.

Various embodiments of the method 300, may comprise a surveying step in which a potential buyer 103 who has reached the central managing authority 102 via the Internet directly (without using a QR Code) is prompted to answer a series of questions about the QR Code 107 specifically or QR Codes generally, such as: Did you see the black and white box? Did you see the QR Code? What is a QR Code? Would you like to download QR software of codexes? Why did you contact the central managing authority? How many times did you see the signage before scanning it? And when did you scan the signage? Where did you see the signage you scanned?

The teachings of the present invention in the surveying step are directed to the denotation of the question formed by the words, not the exact wordings themselves.

In various embodiments of the present invention, the central managing authority may tutor the potential buyer 103 on what QR Codes 107 are and how the potential buyer 103 can make use of them in the future.

Next, this contact information 116 is stored 506 in persistent storage where it can be eventually or immediately transmitted to other third-parties.

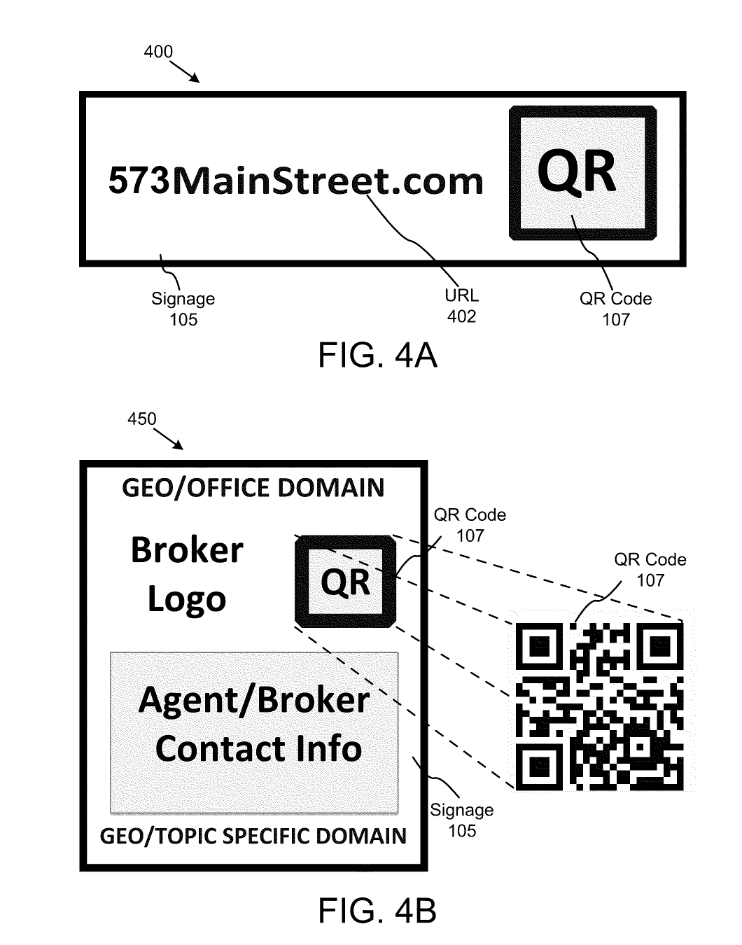

FIG. 4A is a front perspective view of signage 400 printed in accordance with the present invention. The signage 400 includes a sign 105, a QR Code 107, and URL 402.

In some embodiments of the present invention, the QR Code 107 directs potential buyers 103 to a geo-specific domain name or URL 402, meaning the domain name itself or URL 402 denotes information specific to the real estate offered for sale, such as the real estates address as shown in FIG. 4A.

FIG. 4B is a front perspective view of another embodiment of signage 450 printed in accordance with the present invention. The signage 450 includes a sign 105, a QR Code 107, and URL 402.

The QR Code 107 shown in the expanded view of this embodiment directs users to the domain name <573main.com>, rather than the domain name <573mainstreet.com> which may be shown in printed in text on the signage 105 in some embodiments. By directing potential buyers 103 to a different base domain when they manually key the domain name than when the potential buyer 103 scans the QR Code 107, the present invention teaches new means of tracking how potential buyers 103 arrived at information stored by the central managing authority 102 and displayed to potential buyers 103 via the Internet.

Because the domain name referenced in the QR Code 107 differs from the domain name printed on the signage 105, the central managing authority 102 can identify the method that a potential customer 103 used to reach the central managing authority 102.

The “base domain name” is defined, for the purposes of this invention, to denote the domain name registered with an ICANN approved registrar and appearing immediately before the gTLD (generic top-level domain), ccTLD (internationalized top-level domain), and the like, rather than after the gTLD, or a sub-domain, etcetera.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable medium having computer usable program code executable to perform operations for procuring, identifying, and tracking potential buyers of a commercial product, the operations of the computer program product comprising:
printing signage bearing a two-dimensional matrix bar code, wherein said matrix bar code stores object hyperlinks to a URL exclusively associated with the signage, wherein said signage advertises a commercial product;
storing the physical location of the signage in a database under the exclusive control of a central managing authority intending to profit from the sale of the commercial product;
storing tracking information comprising the time, date, and location where the signage was scanned by a potential buyer, wherein said tracking information is derived from scripts embedded into the source code of a website to which the URL resolves;
displaying information to the potential buyer about a commercial product via the website to which the URL resolves;
requesting personal information about the potential buyer via the website;
incorporating the personal information of the potential buyer into the database, said personal information structured in one or more computer readable files and comprising one or more of name, address, email, telephone number, employer, income, and profession;
referencing the personal information and the tracking information in determining whether to reposition the signage; and
referencing the personal information and the tracking information in determining where to situate new signage.

2. The computer program product of claim 1, wherein the commercial product is real property.

3. The computer program product of claim 1, wherein the matrix bar code is a QR Code.

4. The computer program product of claim 1, wherein the signage comprises a portable device selected from the group consisting of a shirt, grocery bag, hat, car, soda bottle, and kite.

5. The computer program product of claim 1, wherein the signage comprises more than one matrix bar code combined into a lenticular print.

6. The computer program product of claim 5, wherein the lenticular print is configured such that only one matrix bar code is visible from one or more predetermined positions relative to the signage.

7. The computer program product of claim 6, further comprising tracking the position from which a potential buyer was induced to contact the central managing authority.

8. The computer program product of claim 1, further comprising predetermining an ideal physical location to display the signage by querying a database of available signage locations and by querying statistical historical data specific to a geographic location, the statistical historical data comprising one or more of traffic figures, population figures, demographic information, promotional expenditures for organizations competing with the central managing authority, reported profits, and fixed costs assigned to available signage locations.

9. The computer program product of claim 1, further comprising repositioning the signage to a second ideal physical location as historical data in the database is updated and after the signage is originally positioned.

10. The computer program product of claim 1, wherein the signage further comprises an active RFID tag.

11. The computer program product of claim 1, wherein the signage further comprises a passive RFID tag.

12. The computer program product of claim 1, further comprising notifying a client of the central managing authority that the one or more potential buyers have contacted the central managing authority through the URL.

13. The computer program product of claim 1, further comprising remunerating a third-party for each contact made with the central managing authority by a potential buyer.

14. The computer program product of claim 1, wherein the signage is printed in colors automatically determined to contrast with the topography surrounding the location of the signage.

15. The computer program product of claim 1, wherein the size of the text printed on the signage is determined by referencing the distance between the location of the signage and the location of one or more groups of potential buyers likely to view the signage.

16. A system to perform operations for procuring, identifying, and tracking potential buyers of a commercial product, the system comprising:
a print module configured to print signage bearing a two-dimensional matrix bar code, wherein said matrix bar code stores object hyperlinks to a URL exclusively associated with the signage, wherein said signage advertises a commercial product;
a storage module configured to store the physical location of the signage in a database under the exclusive control of a central managing authority intending to profit from the sale of the commercial product;
a tracking module configured to track information comprising the time, date, and location where the signage was photographed by a potential buyer, wherein said tracking information is derived from scripts embedded into the source code of a website to which the URL resolves;
a display module configured to display information to the potential buyer about a commercial product via the website to which the URL resolves;
a request module configured to request personal information about the potential buyer via the website;
a personal information module configured to incorporate the personal information of the potential buyer into the database, said personal information structured in one or more computer readable files and comprising one or more of name, address, email, telephone number, employer, income, and profession;
a query module configured to reference the personal information and the tracking information in determining whether to reposition the signage; and
a reference module configured to reference the personal information and the tracking information in determining where to situate new signage.

17. A method for procuring, identifying, and tracking potential buyers of a commercial product, the steps of the method comprising:
printing signage bearing a two-dimensional matrix bar code, wherein said matrix bar code stores object hyperlinks to a URL exclusively associated with the signage, wherein said signage advertises a commercial product;
storing the physical location of the signage in a database under the exclusive control of a central managing authority intending to profit from the sale of the commercial product;
storing tracking information comprising the time, date, and location where the signage was photographed by a potential buyer, wherein said tracking information is derived from scripts embedded into the source code of a website to which the URL resolves;
displaying information to the potential buyer about a commercial product via the website to which the URL resolves;
requesting personal information about the potential buyer via the website;
incorporating the personal information of the potential buyer into the database, said personal information structured in one or more computer readable files and comprising one or more of name, address, email, telephone number, employer, income, and profession;
referencing the personal information and the tracking information in determining whether to reposition the signage; and
referencing the personal information and the tracking information in determining where to situate new signage.

18. The method of claim 17, wherein the signage comprises more than one matrix bar code combined into a lenticular print.

19. The method of claim 20, wherein the lenticular print is configured such that only one matrix bar code is visible from one or more predetermined positions relative to the signage.

20. The method of claim 19, further comprising tracking the position from which a potential buyer was induced to contact the central managing authority.

21. The method of claim 17, further comprising surveying the potential customer by prompting the potential customers to answer one or more questions selected from the group comprising: where did you see the signage you scanned? Why did you contact the central managing authority? How many times did you see the signage before scanning it? And when did you scan the signage?
